(19) United States
(12) Patent Application Publication
(10) Pub. No.: US 2005/0220526 A1
(43) Pub. Date: Oct. 6, 2005

(54) Easyreceipt electronic receipt storage deivce

(76) Inventors: Eunice L. Meyers, Silver Spring, MD (US); Michelle Nelson, Silver Spring, MD (US)

Correspondence Address: EUNICE L MEYERS, 800 EDELBLUT DRIVE, SILVER SPRING, MD, 20901, US

(21) Appl. No.: 11/097,911

(22) Filed: Apr. 4, 2005

Related U.S. Application Data
(60) Provisional application No. 60/558,775, filed on Apr. 2, 2004.

(51) Int. Cl. B41J 29/02

(52) U.S. Cl. 400/693; 400/88

(57) ABSTRACT

The EASYRECEIPT device stores, organizes and files paper receipts electronically to be uploaded to accounting and tax preparation software. EASYRECEIPT is capable of storing receipts up to four inches wide and any length in memory. Receipts too wide for the device can be entered manually using the alphanumeric indicators. The device allows the categorization of receipts based on user preferences. Difficult to read receipts can be magnified on display screen and reproduced in larger type size than the original. Users select the actions to perform through a menu of options visible on the display screen. There is a slide-out bin on the side for hard-copy storage.

### CROSS-REFERENCE TO RELATED APPLICATIONS

This application claims the benefit of provisional application No. 60/558,775.

### STATEMENT REGARDING FEDERALLY SPONSORED RESEARCH OR DEVELOPMENT

Not Applicable

### REFERENCE TO SEQUENCE LISTING, A TABLE OR A COMPUTER PROGRAM LISTING COMPACT DISC APPENDIX

Not Applicable

### BACKGROUND OF THE INVENTION

Paper receipts are a part of everyone's daily existence. The end result of every purchase and banking transaction is a paper receipt. Receipts are required to prove expenditures for tax or business purposes, return items, and file warranty claims. By default, the number of receipts accumulated can be numerous based on the number of purchases and transactions made over the course of time. Paper receipts are a nuisance to keep track and organized. Often receipts are lost, misplaced, or illegible.

### BRIEF SUMMARY OF THE INVENTION

The present invention was created to solve the aforementioned problems by easily creating and storing electronic files from paper receipts of which can be transferred electronically to other popular computer programs.

The primary benefits of EASYRECEIPT are: (1) the ability to upload receipt to popular accounting and tax preparation software; (2) the ability to categorize and organize expenditures; (3) and the ability to store large volumes of historical data. Currently, there is no such device on the market today.

The capability of the present invention to store data files to memory permits the device to be used with or without additional equipment. The file storage capability will eliminate or lessen the need to keep paper copies of receipts. Electronic receipt data files can be printed directly from the device when needed.

The present invention can be used to magnify hard to read paper receipts by enlarging data on the display screen.

Another aspect of the present invention allows for transfer of data files electronically for use by other computer programs such as accounting and tax filing software.

The transfer of files from the present invention to other computer programs augments the file storage capacity allowing for other forms of storage such as CDROM.

### BRIEF DESCRIPTION OF THE SEVERAL VIEWS OF THE DRAWING

Not Applicable

### DETAILED DESCRIPTION OF THE INVENTION

The EASYRECEIPT Electronic receipt storage device, hereafter referred to as “EASYRECEIPT”, is approximately 6.5 inches wide, 3 inches high, and 5 inches deep. It is encased in high quality hard plastic and has a slide-out bin on the side. The top has alphanumeric indicators and 2 inch wide by 1-inch high display screen. A four-inch wide opening (or slot) runs along the top of the device about ¼ inch from the display screen. The back of the device has several ports and an AC adapter slot. Additional compartments house a battery and 4 inch wide paper.

1. A receipt storage device capable of reading, storing, reproducing, magnifying and transmitting hard copy receipt data and/or manually input receipt data;
(a) main unit encased in plastic housing;
(b) display screen on top of unit for viewing receipt data;
(c) alphanumeric keypad positioned below said display screen for entering data;
(d) function keys to manipulate receipt data;
(f) ports;
(g) slide-out paper storage drawer located on side of unit;
(h) paper feed to reproduce receipts;
